(19) United States
(12) Patent Application Publication
(10) Pub. No.: US 2026/0062048 A1
(43) Pub. Date: Mar. 5, 2026

(54) STEER-BY-WIRE ADAS MODE OVERRIDE STRATEGY

(71) Applicant: Steering Solutions IP Holding Corporation, Saginaw, MI (US)

(72) Inventors: Kaiser XU, Suzhou (CN); Roger XU, Suzhou (CN)

(21) Appl. No.: 18/883,194

(22) Filed: Sep. 12, 2024

(30) Foreign Application Priority Data
Aug. 29, 2024 (CN) 2024112003254

(51) Int. Cl. B62D 5/04; B62D 6/00; B62D 15/02

(52) U.S. Cl. CPC B62D 5/0463; B62D 6/002; B62D 15/025

(57) ABSTRACT

A system for controlling a steering system of a vehicle includes sensors configured to sense a plurality of values corresponding to operation of the steering system and a steering system controller configured to receive the sensed plurality of values, the sensed plurality of values including a torque value, determine a scale value based on the torque value, the scale value varying based on changes in the torque value, and control a roadwheel position of the steering system based on the scale value.

### CROSS-REFERENCE TO RELATED APPLICATIONS

This application claims the benefit of Chinese Application No. 2024112003254, filed on Aug. 29, 2024. The entire disclosure of the application referenced above is incorporated herein by reference.

### TECHNICAL FIELD

This disclosure relates to cooperative vehicle operation, and in particular to cooperative driving in an advanced driver assistance system mode.

### BACKGROUND OF THE INVENTION

A vehicle, such as a car, truck, sport utility vehicle, crossover, mini-van, marine craft, aircraft, all-terrain vehicle, recreational vehicle, or other suitable forms of transportation, typically includes a steering system, such as an electronic power steering (EPS) system, a steer-by-wire (SbW) steering system, a hydraulic steering system, or other suitable steering system. The steering system of such a vehicle typically controls various aspects of vehicle steering including providing steering assist to an operator of the vehicle, controlling steerable wheels of the vehicle, and the like.

Increasingly, such vehicles are including or using advanced driver assistance systems that assist (e.g., autonomously or semi-autonomously) in one or more vehicle operations, such as vehicle steering and/or other vehicle operation. Under certain conditions, the driver of the vehicle and the advanced driver assistance system may cooperatively perform such vehicle operations.

### SUMMARY OF THE INVENTION

This disclosure relates generally to cooperative vehicle operation between a driver and an advanced driver assistance system (ADAS).

An aspect of the disclosed embodiments includes a system for controlling a steering system of a vehicle that includes sensors configured to sense a plurality of values corresponding to operation of the steering system and a steering system controller configured to receive the sensed plurality of values, the sensed plurality of values including a torque value, determine a scale value based on the torque value, the scale value varying based on changes in the torque value, and control a roadwheel position of the steering system based on the scale value.

These and other aspects of the present disclosure are disclosed in the following detailed description of the embodiments, the appended claims, and the accompanying figures.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1A generally illustrates a vehicle according to the principles of the present disclosure.

FIG. 1B generally illustrates a controller according to the principles of the present disclosure.

FIG. 2 generally illustrates an example rack or RWA controller and column or handwheel actuator (HWA) controller of a steering system configured to implement the ADAS override techniques according to the principles of the present disclosure.

FIG. 3 generally illustrates an example scale value according to the principles of the present disclosure.

FIG. 4 is a flow diagram generally illustrating an ADAS override method according to the principles of the present disclosure.

### DETAILED DESCRIPTION

The following discussion is directed to various embodiments of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

As described, a vehicle, such as a car, truck, sport utility vehicle, crossover, mini-van, marine craft, aircraft, all-terrain vehicle, recreational vehicle, or other suitable forms of transportation, typically includes a steering system, such as an electronic power steering (EPS) system, a steer-by-wire (SbW) steering system, a hydraulic steering system, or other suitable steering system. The steering system of such a vehicle typically controls various aspects of vehicle steering including providing steering assist to an operator of the vehicle, controlling steerable wheels of the vehicle, and the like.

Some vehicles include or use an advanced driver assistance system (ADAS) that assists (e.g., autonomously or semi-autonomously) in one or more vehicle operations, such as vehicle steering and/or other vehicle operation. Under certain conditions, the driver of the vehicle and the advanced driver assistance system may cooperatively perform such vehicle operations.

SbW steering systems that implement ADAS features may include various driving modes, such as manual driving, cooperative driving, and autonomous driving modes. In the manual driving mode, a roadwheel actuator (RWA) follows only a position command from a handwheel actuator (HWA) (e.g., a steering wheel) only and the driver alone controls steering. In the cooperative driving mode, the RWA is responsive to position commands from both the HWA and the ADAS (e.g., for Level 2 ADAS techniques and some Level 3 ADAS techniques). In the autonomous driving mode, the RWA is responsive to a position command only from the ADAS (e.g., for Level 3 and above ADAS techniques).

In the cooperative driving mode, manual (i.e., driver) control may override ADAS control in various conditions. For example, as force applied by the driver to the HWA increases, the RWA increases responsiveness to the position command from the HWA and decreases responsiveness to the ADAS (i.e., RWA control “scales” from the ADAS to the driver/HWA). In some examples, transitioning from ADAS control to HWA control (i.e., overriding ADAS) in this manner can cause a sudden “step” change in vehicle dynamics or steering effort, may cause an unintended override of the ADAS, and/or may result in a delayed override of the ADAS.

Accordingly, ADAS override systems and methods according to the present disclosure are configured to improve vehicle and steering dynamics during ADAS override and transitions between ADAS and HWA control of the RWA. For example, in some control schemes, torsion bar (Tbar) or handwheel torque exceeding a torque threshold can cause ADAS to be overridden, which may result in a step change in lateral motion of the vehicle. Systems and methods according to the present disclosure scale RWA position control based on Tbar torque. As one example, Tbar torque is used to calculate a RackPosRef scale value for RWA position control. Accordingly, rather than an abrupt override when Tbar torque exceeds a torque threshold, the override effect is gradual as Tbar torque increases, preventing a sudden step change of RackPosRef. In other examples, HWA position control is further modified to improve an override time of ADAS, and slew rate control is also applied to the scale value to avoid quick lateral motion of the vehicle.

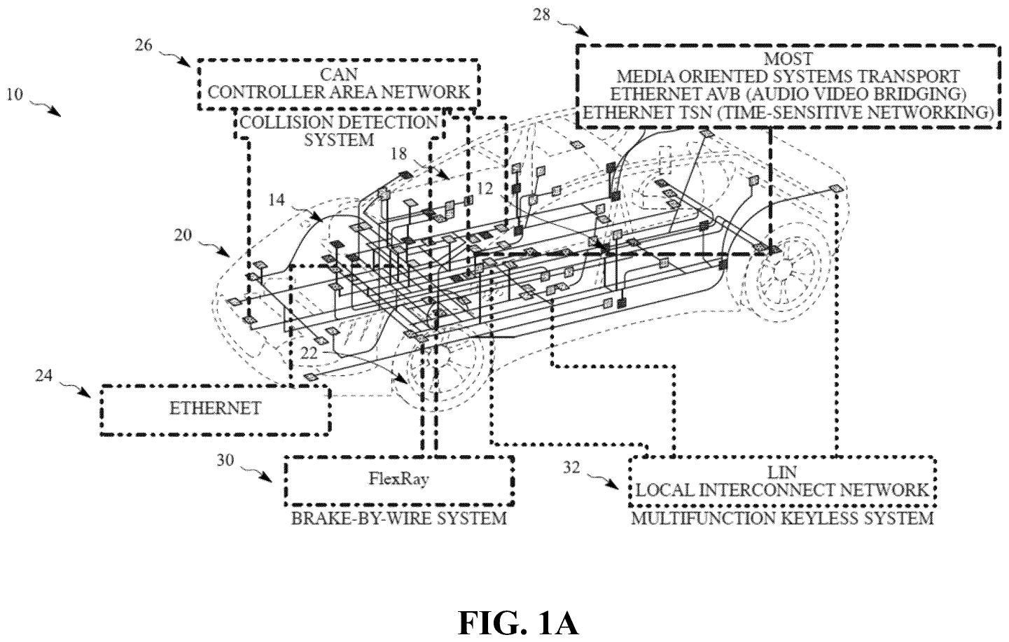

FIG. 1A generally illustrates a vehicle 10 according to the principles of the present disclosure. The vehicle 10 may include any suitable vehicle, such as a car, a truck, a sport utility vehicle, a mini-van, a crossover, any other passenger vehicle, any suitable commercial vehicle, or any other suitable vehicle. While the vehicle 10 is illustrated as a passenger vehicle having wheels and for use on roads, the principles of the present disclosure may apply to other vehicles, such as planes, boats, trains, drones, or other suitable vehicles

The vehicle 10 includes a vehicle body 12 and a hood 14. A passenger compartment 18 is at least partially defined by the vehicle body 12. Another portion of the vehicle body 12 defines an engine compartment 20. The hood 14 may be moveably attached to a portion of the vehicle body 12, such that the hood 14 provides access to the engine compartment 20 when the hood 14 is in a first or open position and the hood 14 covers the engine compartment 20 when the hood 14 is in a second or closed position. In some embodiments, the engine compartment 20 may be disposed on rearward portion of the vehicle 10 than is generally illustrated.

The passenger compartment 18 may be disposed rearward of the engine compartment 20, but may be disposed forward of the engine compartment 20 in embodiments where the engine compartment 20 is disposed on the rearward portion of the vehicle 10. The vehicle 10 may include any suitable propulsion system including an internal combustion engine, one or more electric motors (e.g., an electric vehicle), one or more fuel cells, a hybrid (e.g., a hybrid vehicle) propulsion system comprising a combination of an internal combustion engine, one or more electric motors, and/or any other suitable propulsion system.

In some embodiments, the vehicle 10 may include a petrol or gasoline fuel engine, such as a spark ignition engine. In some embodiments, the vehicle 10 may include a diesel fuel engine, such as a compression ignition engine. The engine compartment 20 houses and/or encloses at least some components of the propulsion system of the vehicle 10. Additionally, or alternatively, propulsion controls, such as an accelerator actuator (e.g., an accelerator pedal), a brake actuator (e.g., a brake pedal), a handwheel, and other such components are disposed in the passenger compartment 18 of the vehicle 10. The propulsion controls may be actuated or controlled by an operator of the vehicle 10 and may be directly connected to corresponding components of the propulsion system, such as a throttle, a brake, a vehicle axle, a vehicle transmission, and the like, respectively. In some embodiments, the propulsion controls may communicate signals to a vehicle computer (e.g., drive by wire) which in turn may control the corresponding propulsion component of the propulsion system. As such, in some embodiments, the vehicle 10 may be an autonomous vehicle.

In some embodiments, the vehicle 10 includes a transmission in communication with a crankshaft via a flywheel or clutch or fluid coupling. In some embodiments, the transmission includes a manual transmission. In some embodiments, the transmission includes an automatic transmission. The vehicle 10 may include one or more pistons, in the case of an internal combustion engine or a hybrid vehicle, which cooperatively operate with the crankshaft to generate force, which is translated through the transmission to one or more axles, which turns wheels 22. When the vehicle 10 includes one or more electric motors, a vehicle battery, and/or fuel cell provides energy to the electric motors to turn the wheels 22.

The vehicle 10 may include automatic vehicle propulsion systems, such as a cruise control, an adaptive cruise control, automatic braking control, other automatic vehicle propulsion systems, or a combination thereof. The vehicle 10 may be an autonomous or semi-autonomous vehicle, or other suitable type of vehicle. The vehicle 10 may include additional or fewer features than those generally illustrated and/or disclosed herein.

In some embodiments, the vehicle 10 may include an Ethernet component 24, a controller area network (CAN) bus 26, a media oriented systems transport component (MOST) 28, a FlexRay component 30 (e.g., brake-by-wire system, and the like), and a local interconnect network component (LIN) 32. The vehicle 10 may use the CAN bus 26, the MOST 28, the FlexRay Component 30, the LIN 32, other suitable networks or communication systems, or a combination thereof to communicate various information from, for example, sensors within or external to the vehicle, to, for example, various processors or controllers within or external to the vehicle. The vehicle 10 may include additional or fewer features than those generally illustrated and/or disclosed herein.

In some embodiments, the vehicle 10 may include a steering system, such as an EPS system, a steering-by-wire steering system (e.g., which may include or communicate with one or more controllers that control components of the steering system without the use of mechanical connection between the handwheel and wheels 22 of the vehicle 10), a hydraulic steering system (e.g., which may include a magnetic actuator incorporated into a valve assembly of the hydraulic steering system), or other suitable steering system.

The steering system may include an open-loop feedback control system or mechanism, a closed-loop feedback control system or mechanism, or combination thereof. The steering system may be configured to receive various inputs, including, but not limited to, a handwheel position, an input torque, one or more roadwheel positions, other suitable inputs or information, or a combination thereof.

Additionally, or alternatively, the inputs may include a handwheel torque, a handwheel angle, a motor velocity, a vehicle speed, an estimated motor torque command, other suitable input, or a combination thereof. The steering system may be configured to provide steering function and/or control to the vehicle 10. For example, the steering system may generate an assist torque based on the various inputs. The steering system may be configured to selectively control a motor of the steering system using the assist torque to provide steering assist to the operator of the vehicle 10.

In some embodiments, the vehicle 10 may include a controller, such as controller 100, as is generally illustrated in FIG. 1B. The controller 100 may correspond to a steering system controller. The controller 100 may include any suitable controller, such as an electronic control unit or other suitable controller. The controller 100 may be configured to control, for example, the various functions of the steering system and/or various functions of the vehicle 10. The controller 100 may include a processor 102 and a memory 104. The processor 102 may include any suitable processor, such as those described herein. Additionally, or alternatively, the controller 100 may include any suitable number of processors, in addition to or other than the processor 102. The memory 104 may comprise a single disk or a plurality of disks (e.g., hard drives), and includes a storage management module that manages one or more partitions within the memory 104. In some embodiments, memory 104 may include flash memory, semiconductor (solid state) memory or the like. The memory 104 may include Random Access Memory (RAM), a Read-Only Memory (ROM), or a combination thereof. The memory 104 may include instructions that, when executed by the processor 102, cause the processor 102 to, at least, control various aspects of the vehicle 10. Additionally, or alternatively, the memory 104 may include instructions that, when executed by the processor 102, cause the processor 102 to perform functions associated with the systems and methods described herein.

The controller 100 may receive one or more signals from various measurement devices or sensors 106 indicating sensed or measured characteristics of the vehicle 10. The sensors 106 may include any suitable sensors, measurement devices, and/or other suitable mechanisms. For example, the sensors 106 may include one or more torque sensors or devices, one or more handwheel position sensors or devices, one or more motor position sensor or devices, one or more position sensors or devices, other suitable sensors or devices, or a combination thereof. The one or more signals may indicate a handwheel torque, a handwheel angle, a motor velocity, a vehicle speed, other suitable information, or a combination thereof.

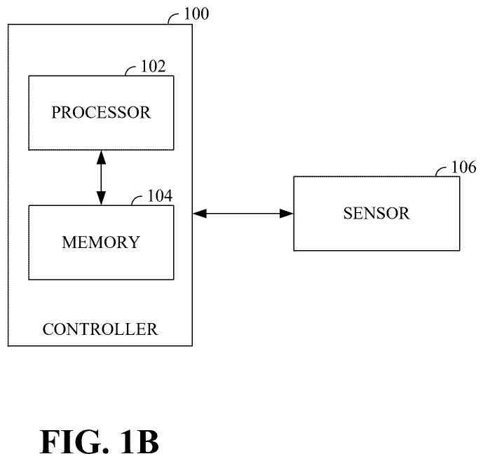

FIG. 2 illustrates an example rack or RWA controller 200 and column or handwheel actuator (HWA) controller 204 of a steering system configured to implement the ADAS override techniques according to the present disclosure. For example, the HWA controller 204 is configured to generate a handwheel actuator (HWA) motor torque command based on an estimated rack force (e.g., an estimated rack force signal) received from the RWA controller 200 and one or more other input signals (e.g., vehicle speed, handwheel position, and handwheel velocity). The RWA controller 200 is configured to determine the estimated rack force based on an actual rack position (e.g., a signal indicating the actual rack position) and a rack position reference value or signal (e.g., a rack position reference indicative of a target rack position). The controllers 200 and 204 may correspond to, be implemented by, etc. one or more steering system controllers.

As one example, the HWA controller 204 includes a reference torque calculator 208 configured to calculate a reference torque (T_{ref}) based on the estimated rack force and the one or more other input signals. For example, the reference torque corresponds to a sum of various inputs/measurements such as effort, hysteresis, return correction, damping return, catch, etc. A closed loop (e.g., a PID closed loop) torque controller 212 is configured to generate and output the motor torque command based at least in part on Tbar torque and the reference torque. The motor torque command is provided as a control signal to control a motor of the handwheel actuator.

The estimated rack force corresponds to a target value for the motor torque command. Accordingly, the estimated rack force (and any estimated rack force offset or error) is a critical factor for determining the force provided by the motor of the handwheel actuator.

In some examples, the HWA controller 204 may further include a C-factor lookup module 216 and a rack position reference calculator 220. For example, the rack position reference calculator 220 is configured to generate the rack position reference based on a C-factor received from the C-factor lookup module 216. The C-factor may be determined based on a handwheel angle (“HwAg”) corresponding to driver input (e.g., a handwheel angle indicating driver intent conveyed via the handwheel). Example systems and methods for obtaining the rack position reference and the C-factor are described in more detail in U.S. pat. app. Ser. No. 18/318,657, filed on May 16, 2023, the entire contents of which are incorporated herein by reference.

In some examples, the HWA controller 204 may further include a column position controller 218. The column position controller 218 is configured to control the HWA to follow the movement of the RWA. In other words, the column position controller 218 may control rotation of the HWA to correspond to movement of the RWA. As one example, the column position controller 218 implements closed loop, PID control. The column position controller 218 may be responsive to inputs including, but not limited to, handwheel position/angle, rack position reference and measurement signals, etc. A reference torque may be calculated based in part on an output of the column position controller 218.

The RWA controller 200 includes a rack position controller 224 (e.g., a PID rack position controller) configured to generate one or more rack position control signals based on the actual rack position and the rack position reference (e.g., based on a difference between the actual rack positon and the rack position reference). For example, the rack position control signals may include, but are not limited to, rack motor velocity and motor torque command (e.g., indicative of an amount of torque applied by the driver) signals. In this manner, rack position is controlled to follow the intent of the driver (as indicated by the rack reference position).

A rack force predictor 228 generates the estimated rack force based on outputs of the rack position controller 224 (e.g., based on a function of the rack motor velocity, the rack motor torque command, etc.). In various examples, the estimated rack force may be calculated based on the amount of torque applied to the handwheel by the driver (as indicated by the rack motor torque command, various sensor signals, etc.).

For example, for RWA position control, the rack position reference signal (“RackPosRef”) may be calculated based on a position error (“PosErr”) between an ADAS rack position reference value or signal (“ADASRackPosRef”) and an HWA rack position reference value or signal (“HWARackPosRef”). Conversely, HWA position control is based on a position error between the HWA position and the RWA position, such that the handwheel can be controlled to rotate in a manner consistent with rotation of the roadwheel in hands-off conditions. For HWA torque control, the output of the column position controller 218 is added to the reference torque and a final handwheel torque is controlled by the closed loop torque controller 212.

In a cooperative driving mode, manual control may override ADAS control as force applied by the driver (e.g., Tbar torque) to the HWA increases. In an example, RWA control “scales” from the ADAS to the driver/HWA. In some examples, transitioning from ADAS control to HWA control can cause a sudden “step” change in vehicle dynamics or steering effort, may cause an unintended override of the ADAS, and/or may result in a delayed override of the ADAS. For example, RWA control may change from ADAS to HWA in response to Tbar torque reaching a threshold (i.e., ADAS is overridden when Tbar torque reaches the threshold). However, transitioning to HWA control in this manner results in a current Tbar torque (i.e., the Tbar torque that reached or exceeded the threshold) being applied to the RWA control mechanism, which may cause a step change (e.g., an abrupt increase) in lateral motion. As another example, ADAS is overridden in response to an error between the HWA rack position reference signal and the ADAS rack position reference signal exceeding a threshold. In other words, since the HWA rack position reference signal indicates that the driver is applying force to the handwheel, ADAS is overridden in response to the HWA rack position reference signal being significantly different from the ADAS rack position reference signal (i.e., the driver takes over steering from the ADAS).

The HWA controller 204 (or, in some examples, the RWA controller 200) according to the principles of the present disclosure includes an ADAS override controller 232. The ADAS override controller 232 is configured to control the transition from ADAS control to HWA control based on Tbar torque. However, rather than simply transitioning to HWA control in response to Tbar torque reaching a threshold, the ADAS override controller 232 calculates a scale or scaling value based on the Tbar torque and transitions from ADAS control to HWA control based on the Tbar torque and the scale value.

For example, RWA position control (as implemented by the rack position controller 224) as performed based on the rack position reference signal incorporates the scale value as described below in more detail. As an example, the rack position reference signal (“RWARackPosRef”) is calculated in accordance with:

RWARackPosRef=Scale*ADASRackPosRef+(1−SCALE)*HWARackPosRef, where SCALE is the scale value. (EQUATION 1)

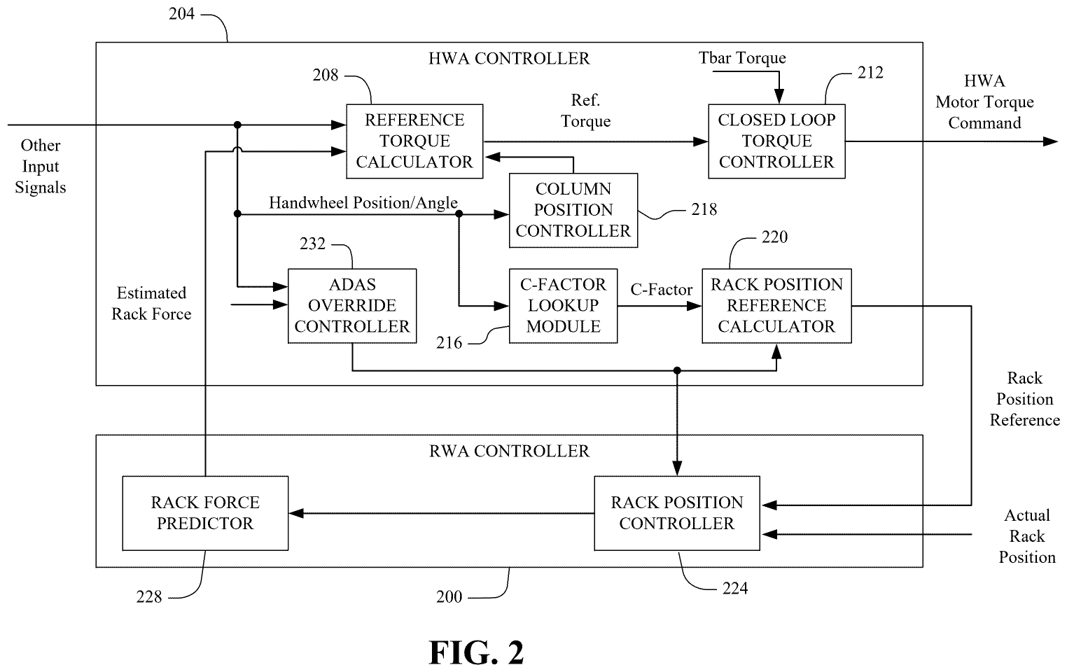

As shown in FIG. 3, an example scale value 300 decreases as Tbar torque increases. In other examples, the scale value 300 increases as Tbar torque increases. In some examples (as shown), the scale value 300 has a constant or substantially constant (i.e., non-decreasing) region 304. For example, the scale value 300 may be relatively constant when Tbar torque is low, and begins to decrease when Tbar torque exceeds a first threshold as shown at 308. A decrease rate of the scale value 300 and/or a second threshold may be selected such that the second threshold for the Tbar torque corresponds to a torque at which the scale value 300 reaches 0 as shown at 312. Accordingly, when the transition from ADAS control to HWA control is complete (i.e., responsive to Tbar torque reaching the second threshold), the ADASRackPosRef term in Equation 1 is already reduced to zero (due to multiplication by a zero or near-zero scale value), while the HWARackPosRef term is multiplied by approximately one, and a step change is avoided. In other words, as force applied by the driver to the handwheel (Tbar torque) increases, the contribution of HWARackPosRef increases as the contribution of ADASRackPosRef decreases, eliminating any step change when Tbar torque ultimately exceeds the second threshold.

Conversely, HWA position control may be based on an error between HWARackPosRef and ADASRackPosRef. Accordingly, handwheel torque will continue to increase as the error between HWARackPosRef and ADASRackPosRef increases. In some examples, a handwheel velocity damping factor may be provided to the column position controller 218 (e.g., added to the output of the column position controller 218) to avoid handwheel overshoot upon transitioning to HWA control. Similarly, a slew rate control factor may be provided to the column position controller 218 to avoid step changes (e.g., quick lateral motion) of handwheel torque upon ADAS override.

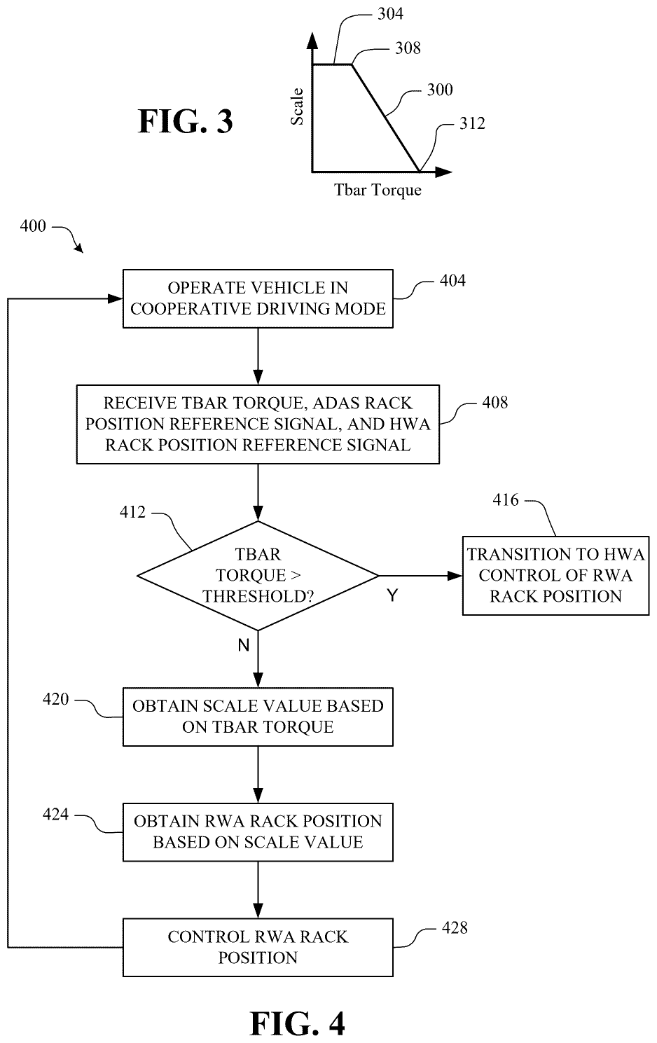

FIG. 4 is a flow diagram generally illustrating an ADAS override method 400 according to the principles of the present disclosure. For example, one or more computing devices, processors or processing devices, etc. are configured to execute instructions to implement the method 400, such as one or more of the processors of the systems described herein (e.g., a computing device or processor of a vehicle configured to implement the controllers 200, 204, etc.). One or more of the steps of the method 400 as described below may be skipped or omitted in some examples, and/or one or more of the steps may be performed in a different sequence than described.

At 404, the method 400 includes operating a vehicle in a cooperative driving mode in which the RWA is responsive to position commands from both the HWA (i.e., the driver) and the ADAS. At 408, the method 400 includes receiving various inputs (e.g., signals, measurements, etc.) used to control RWA position in accordance with the principles of the present disclosure as described herein, including, but not limited to, Tbar torque, the ADAS rack position reference signal, and the HWA rack position reference signal.

At 412, the method 400 includes determining whether Tbar torque has reached a threshold (e.g., is greater than or equal to the threshold, greater than the threshold, etc.). If yes, the method 400 continues to 416. If no, the method 400 continues to 420. At 416, the method 400 transitions to HWA control of RWA rack position as described herein.

At 420, the method 400 includes obtaining a scale value based on the various inputs (e.g., based on the Tbar torque). As one example, the scale value may be obtained using a lookup table that correlates Tbar torque values to scale values. As another example, the scale value may be obtained using a formula or equation configured to calculated scale values using Tbar torque values as inputs.

At 424, the method 400 includes obtaining an RWA rack position based on the scale value. For example, the RWA rack position is obtain in accordance with RWARackPosRef=SCALE*ADASRackPosRef+(1−SCALE)*HWARackPosRef as described herein.

At 428, the method 400 includes controlling RWA rack position based on the RWA rack position obtained at 424.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably.

As used herein, the term module can include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module can include an application specific integrated circuit (ASIC), a Field Programmable Gate Array (FPGA), a circuit, digital logic circuit, an analog circuit, a combination of discrete circuits, gates, and other types of hardware or combination thereof. In other embodiments, a module can include memory that stores instructions executable by a controller to implement a feature of the module.

Further, in one aspect, for example, systems described herein can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations, and aspects have been described in order to allow easy understanding of the present invention and do not limit the present invention. On the contrary, the invention is intended to cover various modifications and equivalent arrangements included within the scope of the appended claims, which scope is to be accorded the broadest interpretation so as to encompass all such modifications and equivalent structure as is permitted under the law.

1. A system for controlling a steering system of a vehicle, the system comprising:
sensors configured to sense a plurality of values corresponding to operation of the steering system; and
a steering system controller configured to, while operating in a cooperative driving mode in which a roadwheel position of the steering system is controlled responsive to both an advanced driver assistance system (ADAS) signal and a handwheel actuator signal,
receive the sensed plurality of values, wherein the sensed plurality of values includes a torque value,
in response to the torque value exceeding a threshold, transition to controlling the roadwheel position based on a handwheel actuator control signal,
in response to the torque value not exceeding the threshold, determine a scale value based on the torque value, wherein the scale value varies based on changes in the torque value,
obtain a roadwheel actuator (RWA) rack position based on the scale value and the ADAS signal, and
control the roadwheel position of the steering system based on the RWA rack position.

2. The system of claim 1, wherein the torque value corresponds to torque applied to a handwheel of the vehicle.

3. The system of claim 1, wherein the scale value decreases as the torque value increases.

4. (canceled)

5. The system of claim 1, wherein the steering system controller is configured to calculate the RWA rack position based on the scale value, a handwheel actuator position reference value, and an ADAS rack position reference value.

6. The system of claim 5, wherein calculating the RWA rack position includes modifying the handwheel actuator position reference value and the ADAS rack position reference value based on the scale value.

7-8. (canceled)

9. A method for controlling a steering system of a vehicle, the method comprising:
sensing a plurality of values corresponding to operation of the steering system; and
while operating in a cooperative driving mode in which a roadwheel position of the steering system is controlled responsive to both an advanced driver assistance system (ADAS) signal and a handwheel actuator signal:
receiving, at a steering system controller, the sensed plurality of values, wherein the sensed plurality of values includes a torque value;
in response to the torque value exceeding a threshold, transitioning to controlling the roadwheel position based on a handwheel actuator control signal;
in response to the torque value not exceeding the threshold, determining a scale value based on the torque value, wherein the scale value varies based on changes in the torque value;
obtaining a roadwheel actuator (RWA) rack position based on the scale value and the ADAS signal, and
controlling the roadwheel position of the steering system based on the RWA rack position.

10. The method of claim 9, wherein the torque value corresponds to torque applied to a handwheel of the vehicle.

11. The method of claim 9, wherein the scale value decreases as the torque value increases.

12. (canceled)

13. The method of claim 9, further comprising calculating the RWA rack position based on the scale value, a handwheel actuator position reference value, and an ADAS rack position reference value.

14. The method of claim 13, wherein calculating the RWA rack position includes modifying the handwheel actuator position reference value and the ADAS rack position reference value based on the scale value.

15-16. (canceled)

17. A processor configured to execute instructions stored in memory, wherein executing the instructions causes the processor to control a steering system of a vehicle, the instructions comprising:
sensing a plurality of values corresponding to operation of the steering system; and
while operating in a cooperative driving mode in which a roadwheel position of the steering system is controlled responsive to both an advanced driver assistance system (ADAS) signal and a handwheel actuator signal:
receiving the sensed plurality of values, wherein the sensed plurality of values includes a torque value;
in response to the torque value exceeding a threshold, transitioning to controlling the roadwheel position based on a handwheel actuator control signal;
in response to the torque value not exceeding the threshold, determining a scale value based on the torque value, wherein the scale value varies based on changes in the torque value;
obtaining a roadwheel actuator (RWA) rack position based on the scale value and the ADAS signal, and
controlling the roadwheel position of the steering system based on the RWA rack position.

18. The processor of claim 17, wherein the torque value corresponds to torque applied to a handwheel of the vehicle.

19. The processor of claim 18, the instructions further comprising:
calculating a roadwheel actuator position based on the scale value, a handwheel actuator position reference value, and an ADAS rack position reference value; and
controlling the roadwheel position in accordance with the roadwheel actuator position.

20. The processor of claim 19, wherein calculating the RWA rack position includes modifying the handwheel actuator position reference value and the ADAS rack position reference value based on the scale value.
